(19) United States
(12) Patent Application Publication
(10) Pub. No.: US 2012/0141735 A1
(43) Pub. Date: Jun. 7, 2012

(54) COATING ARTICLE INTENDED TO BE APPLIED TO A WALL TO BE DECORATED AND ASSOCIATED PRODUCTION METHOD AND APPLICATION METHOD

(76) Inventors: Stanislas Chevallier, La Celle Saint-Cloud (FR); Wilfrid Sourbe, Bordeaux (FR); Héléna Cheminet, Gradignan (FR); Vincent Delsuc, Talence (FR); Jéröme De Dinechin, Versailles (FR)

(21) Appl. No.: 13/376,162

(22) PCT Filed: Jun. 3, 2010
(86) PCT No.: PCT/EP10/57806

§ 371 Date: Feb. 17, 2012

(30) Foreign Application Priority Data
Jun. 3, 2009 (FR) 0953658

(51) Int. Cl. B32B 3/00; D04H 13/00; B32B 7/02; B29C 73/02; D03D 15/00; C03C 25/68; E04F 13/00; B32B 3/26; B32B 27/00

(52) U.S. Cl. 428/141; 428/304.4; 428/292.1; 428/213; 428/195.1; 428/500; 442/187; 442/330; 428/337; 156/45; 156/44; 216/7; 156/71; 264/36.18

(57) ABSTRACT

The mention relates to a sheet coating article (1) intended to be applied to a wall (50), characterised in that it comprises: a tightly tined substrate (10), and a coating layer (20) disposed on the tightly tilting substrate (10).

The present invention relates, generally speaking, to techniques of transposing or transferring decorative layers.

Numerous techniques are already known for transposing a decorative layer, by dry or wet process.

Conventionally, the wet process is the wall paper or decalcomania technique, whereas the dry process involves the use of a pressure sensitive adhesive layer, preserved until use by a peelable film.

In general, these known techniques imply that the decorative layer itself is on a substrate having a certain thickness, which has the effect, in general desired, of glossing over inequalities of the surface that receives the decorative layer.

Furthermore, the document WO-A-2006/084865, teaches decorative layer transposition techniques targeting a result that is visually like that obtained by a conventional painting technique, and which moreover may be implemented in an economic, simple and non soiling manner. One of these techniques employs a first temporary substrate on which a film of material to be painted is applied directly, with limited adhesion forces.

The film being dry, a first adhesive is applied thereto, for example which can be deactivated with water, then against the film a second thin temporary substrate with high deformability and partially absorbent is applied. The first adhesive creates between the film and said second temporary substrate adhesion forces greater than those existing between the film and the first temporary substrate.

After a sufficient drying of the first adhesive, the assembly formed by the second temporary substrate and the film are peeled off by separating them from the first temporary substrate.

The film retained is then bonded onto the second temporary substrate with a second adhesive, the assembly is applied against the definitive substrate, and after drying of the second adhesive, the second temporary substrate is dampened with water then the second temporary substrate is peeled off leaving the film of paint on the definitive substrate.

According to another of the techniques described in this document, an assembly is prepared formed of a temporary substrate and a material to be painted directly applied on it with limited adhesion forces to form a film. After drying, an adhesive is applied onto a definitive substrate and/or onto the film such that, after application of the assembly on said definitive substrate and drying of the adhesive, the temporary substrate can be peeled off leaving the film on the definitive substrate.

According to another technique described in this document, a film of material to be painted is applied directly onto a substrate able to pass in a printing machine, and the dry film is directly printed in this machine.

Furthermore, when the film of paint is a filler layer, the techniques of application of the layer on a wall are again different. Generally speaking, a filler is a layer constituted of binders and mineral fillers, the role of which is to protect the wall on which it is applied, to isolate it and to improve the appearance thereof. It may moreover comprise pigments enabling it to be coloured and to give it a decorative appearance.

The filler may be prepared at the place of application, typically on a worksite, from a powder that is mixed with water, or produced in the factory in the form of paste. It is then applied on the wall to rectify its surface irregularities (holes, fissures, etc.), smoothed and flattened using a float, then dried and sanded down. The operation is generally repeated several times in order to obtain a high quality result.

This method of application of a filler is however long and difficult to implement, and this is especially true when it is wished that the external surface is aesthetic and durable, perfectly flat and smooth. Indeed, the quality of preparation of the background is essentially due to the perfect application of fillers.

Furthermore, the application of the filler releases volatile organic compounds (VOC) which are harmful for the environment.

The present invention aims to propose a sheet article acting as filler and decorative layer that is easy and rapid to apply on a wall little or not prepared. With this aim, the article has a thickness and surface stiffness capable of masking defects or fissures on a wall.

Moreover, this article has a high quality finish, which is obtained by the presence of a decorative surface layer which is already integrated, and by a moulding or micro-moulding type surface treatment. It is thus not necessary to apply an additional layer, unlike the conventional application of a filler.

The invention also aims to propose a method for applying a sheet article on walls to be decorated, as well as an associated article, in which the article is bonded directly against the wall without particular preparation of the surfaces in a rapid and reliable manner. Indeed, the article is already dry at the moment of application, and its surface is robust, or even protected by a moulding substrate.

Another aim of the invention is to propose a sheet article having novel properties, such as surface texturing, the incorporation of decorative components, active or activatable, the capacity of heating, energy recovery, lighting, etc.

According to another aspect, the aim of the invention is to propose a sheet article for application of decorative layers, which can be optionally printed, on any type of wall to be decorated.

The invention moreover aims to propose a method for producing such a sheet article for application of decorative layers on walls, which is simple to implement and inexpensive.

To do this, the invention relates to a sheet filler article intended to be applied on a wall, characterised in that it comprises:
a moulding substrate; and
a filler layer, disposed on a first face of the moulding substrate.

Such an article for filler is thus simple to apply on a wall to be decorated without prior preparation, and makes it possible to obtain a filler having a high quality finish, and even no longer requiring a finishing step of application of paint or decorative filler type.

Certain preferred but non limiting aspects of an article according to the invention are as follows:
the article, comprising an additional layer disposed between the filler layer and the first face of the moulding substrate so as to form a surface layer after the additional layer, is a decorative layer.

Such surface layers confer to the article aesthetic properties difficult to obtain according to conventional production techniques, and make it possible moreover to create an article having active or activatable layers according to the type of surface layers used.
the decorative layer comprises one at least of the components from the following group: a paint, a varnish, coloured, metallic, nacreous particles, microbeads, fluorescent particles, luminescent particles, retro-reflective particles, held or not in a binder;
the surface layer is made of a material able to react with the environment to which it is exposed;
the surface layer is made of a material selected from: a microtextured paint, a water-oil repellent medium, zeolites, antifungal agents, anti-fouling agents, biocides, decontamination agents;
the surface layer has physical and chemical properties activatable with air, water or light;
the surface layer is protected by a temporary protective layer.

Thus, when the article is applied on the wall and when the temporary protective layer is removed, peeled off or dissolved, the intermediate layer can be activated in contact with the surrounding environment.
the article comprises an additional layer on the side of the filler layer opposite to the moulding substrate, so as to constitute an intermediate layer after application of the article on the wall.
the intermediate layer is selected from: a mechanical reinforcement layer, a barrier forming layer, an electrically conductive layer, a layer having electromagnetic properties.

Thanks to the conductive layer, the article may be connected for example to a low voltage source, and components (light emitting diodes, active sensors, sound devices, etc.) supplied with power making it possible to diffuse for example heat, light, sound, electromagnetic waves, etc.

The conductive layer may also play the role of surface sensor by integrating flat or added photovoltaic components, presence sensors, heat sensors, etc.

This conductive layer may finally provide a role of protection against electromagnetic waves by playing a role of Faraday cage for example.
the mechanical reinforcement layer is made of an anti-fissuring material.
the barrier forming layer forms a heat and/or acoustic barrier and is formed with an insulating material and/or a porous material.
the barrier forming layer is a continuous layer forming a barrier to the migration of atomic, molecular or ionic species.
the conductive layer is made in the form selected from: a conductive sheet, a network of resistive wires, a conductive polymer, conductive particles dispersed in a binder.
the article comprises moreover two electrically insulating layers situated on either side of the conductive layer.
the conductive layer includes fittings for its electrical connection with the exterior.
the article moreover comprises thin sensor means connected to said fittings.
the intermediate layer is a layer having ferromagnetic properties formed of ferromagnetic particles contained in a binder; thus, it can make it possible to retain a magnetised component or itself comprise a magnetisation.
the filler layer comprises at least two thicknesses of different materials at least one of which is a filler.
the filler layer comprises a thickness of filler of a first colour and a thickness of paint of a second colour different to the first.

For example, a layer of coloured paint is superimposed over a white filler. The aesthetic rendering of the article is thus improved by virtue of the superposition of filler layers having different colours.
the filler comprises a filler in the form of resin of a flexibility and a thickness making it possible to form the article in a roll.
the filler contains reinforcement fibres.

These fibres, mixed in the filler in paste form, give on drying an additional strength to the filler, thus constituting a mechanical reinforcement actually within the layer. These fibres are for example plant, mineral or metallic, woven or not.
the filler layer includes an embossing on its face opposite to the moulding substrate.

Such an embossing makes it possible to lighten the article, to obtain interesting graphic effects, and to facilitate the application of the article if the wall has localised excessive thickness defects.
the moulding substrate or at least one surface part thereof is selected from the group comprising: polyethylene terephthalate, polyethylenes with additives, siliconised papers, papers coated with a mould release agent, woven and non-woven fibres covered with a film forming agent with low surface energy, silicones, Teflon®.
the first face of the moulding substrate has a controlled surface condition and surface energy.
the first face of the moulding substrate has patterns in hollows and/or in relief.

The use of such a substrate makes it possible to adjust and control the appearance and the quality of the finish of the visible surface of the article while ensuring a facility of demoulding.
the article is conditioned in the form of plate.
the article is conditioned in the form of roll.
the moulding substrate has a thickness comprised between around 5 μm and 100 μm, and more specifically between around 20 and 50 μm.
the filler layer has a thickness comprised between around 0.5 mm and 5 mm.

According to a second aspect, the invention relates to a method for producing an article for dry application of filler on a wall, characterised in that it comprises the steps consisting in:
feeding a machine with a moulding substrate;
applying on one of the faces of the moulding substrate a filler layer; and
drying the filler layer.

This production method is thus clean, easy to implement, and enables a high quality result to be obtained. Thanks to the moulding substrate, the formation of moulded reliefs, the surface appearance is controlled while enabling an easy removal of the moulding substrate.

Certain preferred but non limiting aspects of the method are as follows:
the method comprises a step of application of an additional layer on the moulding substrate prior to the application of the filler, to form an article with surface layer conforming to a first embodiment of the invention.
the method comprises a step of application of another additional layer on the surface layer, to form an article conforming to a second embodiment of the present invention.
the step of application of the additional layer comprises the application of a powder and a treatment of the powder.
the method comprises the application of an additional conductive layer on a first filler layer, and the application of a second filler layer on the conductive layer.
the method comprises moreover the application of a surface treatment on the face of the article opposite to the moulding substrate so as to favour its bonding.

This treatment is for example an embossing by means of a roller with reliefs.
the method comprises among others the subsequent steps consisting in:
separating the moulding substrate from the article; and
printing the surface of the article that was in contact with the moulding substrate in a printing machine.
the method comprises among others the subsequent steps consisting in:
separating the moulding substrate from the article; and
applying a peelable substrate instead of the moulding substrate.

This replacement of the moulding substrate by a peelable substrate allows the manufacturer to conserve these substrates for later production, and to commercialise articles protected by disposable substrates of low value and of low environmental impact.

This operation may be carried out after the printing operation.

The method includes moreover, following the step of drying of the filler layer, a step consisting in rendering the moulding substrate porous by means of a mechanical or chemical method so as to facilitate the drying of the adhesive once the article is in place on the wall.

The major difficulty for the production of the moulding substrate resides in the fact of having both the structuring of the mould, which will provide to the sheet article the desired reliefs, a particular surface condition, and the surface energy which must be both sufficiently high to enable a sufficient wettability, while enabling demoulding after drying. It should be noted that the surface energy to obtain depends on the chosen type of material to be painted, such as a paint or a filler. For example, a glycerophthalic paint will be much more adherent than an acrylic paint, and the filler must have a much lower surface energy if it is wished to be able to demould it easily.

It is known that materials such as siliconised fillers, based on Teflon or other surfaces with low surface energies are unsuitable for an application of paint or fresh mortar. Indeed, in this case, it would form fish eyes, areas where there is no adhesion, and which subsequently do not make it possible to obtain a satisfactory surface condition.

Furthermore, plastics of polypropylene, polyester, polyethylene, polyamide, polychloride type in the untreated state have a high wettability, but after drying, removal would be impossible and would tear off pieces of paint or filler.

Thus, it may be necessary just as well to reduce the surface energy of the moulding film as to increase it.

Furthermore, the moulding substrate is in certain cases microporous, so as to be permeable to water vapour and to enable the drying of the filler to be facilitated.

According to a third aspect, the invention thus relates to a method of producing a moulding substrate for an article as defined above, characterised in that it comprises the following steps:
defining a first material for one face of the moulding substrate;
as a function of a relief effect sought after for the article and the nature of a second material to apply firstly on the first material, defining a target surface condition and surface energy for said face of the moulding substrate, on which the article is intended to be formed, so as in particular to obtain a wettability by said material and a demouldable character of the article after drying; and

(iii) treating one face of a sheet having said first material on said face to obtain the target surface condition and surface energy, to obtain thereby the moulding substrate.

Certain preferred but non limiting aspects of the method are as follows:
the moulding substrate or at least one surface part thereof is selected from the group comprising: polyethylene terephthalate, polyethylenes with additives, siliconised papers, papers coated with a mould release agent, woven and non-woven fibres covered with a film forming agent with low surface energy, silicones, Teflon®.
the thickness of the sheet is comprised between around 5 μm and 100 μm, and more specifically between around 20 and 50 μm.
to obtain the target surface condition, the step (iii) is implemented by abrasion which gives a relief corresponding to the negative of the appearance sought after for the filler.
the abrasion is a mechanical abrasion by sandblasting.
the abrasion combines a chemical attack and the application of a particulate material.

For example, in one embodiment, a sanding by means of ground sand is used for several seconds, or any other means of abrasion making it possible to obtain the desired appearance, such as the application of a chemical treatment involving acids then a deposition of silica.
to obtain the target surface condition, the step (iii) is implemented by formation of hollows and/or reliefs with a technique selected from hot moulding and etching.
the hollows and/or reliefs have a mean geometric period comprised between around 20 and 500 μm; the hollows and/or reliefs of the Surface of the moulding substrate have a characteristic dimension that can range from several tens of microns to 0.5 mm by hot moulding, etching, formation by vacuum, without this being limiting.
to obtain the target surface energy, the step (iii) comprises a treatment selected from: a corona treatment and exposure to a plasma gun.
to obtain the target surface energy, the step (iii) comprises the application of a surface energy modifying product.
the product is a latex, so as to increase the surface energy.
the product is a substance with low intrinsic surface energy, so as to lower the surface energy.

Thus, if the surface energy is too low with respect to the desired result, for example for a mould with deep asperities, the surface energy is increased. On the other hand, if the surface energy is too high, the film of a thickness of several micrometres is coated with a product with low surface energy.

The moulding substrate is then able to be placed in contact with the material to be painted or a surface layer. At the end of drying, it will have given to the filler its surface appearance, and will be easy to peel off.

This moulding substrate is used to produce the article subject of the invention, but also to provide a means of repairing the articles and to mask the joints which could be noticed between two adjacent articles.

According to a fourth aspect, the invention relates to a method of application of an article conforming to the invention on a wall, comprising the steps consisting in:
applying an adhesive on the wall and/or on the free face of the article opposite to the moulding substrate;
applying said free face against the wall;
removing the moulding substrate.

It also relates to a method comprising the steps consisting in:
applying an adhesive on the wall and/or on the free face of the article opposite to the peelable substrate;
applying said free face against the wall;
removing the peelable substrate;

The application of the article according to the invention is thus simple, rapid and clean. Furthermore, no finishing step is necessary: the filler thereby applied already has a high quality finish, and thus has no longer need to be abraded, or covered with paint or a decorative filler.

Certain preferred but non limiting aspects of these application methods are as follows:
the adhesive is a filler in paste form.

It is thus no longer necessary to prepare the surface of the wall on which the article is going to be applied: it suffices to apply roughly a filler layer on the wall, then applying the article according to the invention in order to obtain a high quality result.
the method moreover comprises a step of removal of the temporary protective layer.
the article moreover includes an activatable surface layer on the free surface of the article opposite to the substrate, said intermediate layer being protected by a protective surface layer, and
the method moreover comprises a step during which the temporary protective layer is removed.

According to a fifth aspect, the invention relates to a method of finishing or repairing a wail coated with an article by a method conforming to the invention, comprising the following steps:
application of a filler in paste form similar to that used to form the filler layer of the article on a zone to be finished or to be repaired;
before drying of the filler, application of a moulding substrate similar to that used to form the article against the filler in said zone; and
after a period of drying, removal of the moulding substrate.

Alternatively, the method of finishing or repair, when the article has a surface layer, characterised in that it comprises the following steps:
application of a filler in paste form similar to that used to form the filler layer of the article on a zone to be finished or to be repaired;
before drying of the filler, application of a moulding substrate similar to that used to form the article against the filler in said zone, said moulding substrate bearing a layer similar to said surface layer; and
after a period of drying, removal of the moulding substrate while leaving in place said layer initially borne by the moulding substrate.

Thus, during the application, the boundaries between the areas covered by the articles may be treated by the application of a material to be painted similar to that used for the production of the article, and covered with a piece of moulding substrate. In this way, the surface appearance will be as close as possible to the appearance of an article.

Moreover, in the event of damage to an already bonded article, a repair may be made by applying a material to be painted of formulation similar to that of the article and covering it with a piece of moulding substrate.

Other characteristics, aims and advantages will become clearer on reading the detailed description that follows, and while referring to the appended drawings given by way of non limiting examples and in which:

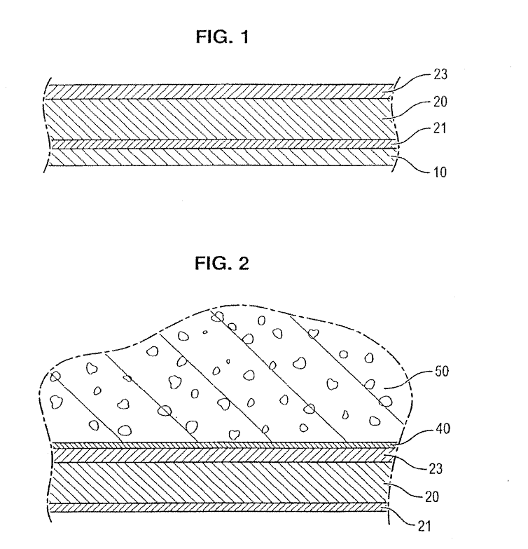

FIG. 1 is a sectional view of an embodiment of an article for filler according to the invention; and

FIG. 2 is a sectional view of a wall on which the article for filler of FIG. 1 has been applied.

With reference firstly to FIG. 1, a sheet article 1 may comprise a moulding substrate 10, a filler layer 20, an additional surface layer 21 having aesthetic properties and/or particular physical and chemical properties, an additional intermediate layer 23, and an adhesive layer 40, all of these layers being able to be present or not as a function of the end result that it is wished to obtain.

In the present description, the term complex is taken to mean the assembly formed by the layers superimposed during the production steps that have already been described.

### The Moulding Substrate

The moulding substrate 10 is adapted to ensure the mechanical cohesion of the article during the phases of production, optional printing and application, and to confer to the visible layer of article 1 the sought after surface finish.

On the moulding substrate 10, which may be flat or comprise relief patterns, is applied the rest of the complex forming the sheet article. It is preferably constituted of a sheet made of polyethylene terephthalate (PET), a degradable polyethylene with additives, a siliconised paper, woven or non-woven fibres covered with a film forming material with low surface energy, a siliconised mould, or instead a machined mould (especially a Teflon plate, smooth or machined).

Typically, the moulding substrate has a thickness ranging from around 10 μm to 500 μm, preferably from around 26 μm to 100 μm, according to the composition of the filler 20 used, its destination and its thickness, in order to facilitate the packaging, the storage and the implementation of the article 1.

As will be seen hereafter, this substrate 10 may be primed to adapt the wettability thereof (and thus the surface energy) and/or the texture and/or the surface reliefs, such that on the one hand the layers deposited on its surface have an adapted cohesion to have a final uniform appearance following their drying, and on the other hand said layers can be demoulded easily.

Said moulding substrate may be supplied alone and in a specific conditioning such as a tape or patches to enable the treatment of joints between articles or localised repairs.

### The Filler Layer 20

The filler layer 20 includes one or more layers of paint, varnish, filler or other, spread over a substrate. The materials of the layers composing the filler 20 may be identical or different, according to the desired effect. The superposition of layers in the layer of material to be painted 20 improves its opacity, its hiding power and may optionally modify the reaction of the material to external light as a function of its characteristics, i.e. whether the light is direct, indirect, strong, weak, etc.

The fillers used may be a filler based on mineral binders and resins, polymers, mono- or multi-component paints of acrylic, glycerophthalic, epoxy nature, or be specific to the type of wall to be decorated 50.

Typically, the quantity of filler forming the layer of material to be painted 20 is situated in a range extending from 500 to 8000 g/m2.

Advantageously, the final filler layer 20 has a thickness ranging from 0.5 mm to 10 mm, preferably from 0.5 mm to 5 mm.

Furthermore, the materials of the layers composing the filler 20 may be identical or different, according to the desired effect. For example, the filler may be applied in two layers on a moulding substrate 10: a first layer, pigmented, and a second layer, natural.

In order that the filler layer 20 remains flexible after drying and to be able to condition the article 1 in the form of a roll, it is possible to use a resin filled filler, by using for example resins of the acrylic resin type.

When the filler includes a low percentage of resins (typically 15%, this percentage corresponding to the percolation threshold of the material), it is rigid and is preferably conditioned in the form of plates. It then includes preferably a reinforcement layer in order to reduce the risks of friability of the plates.

### Additional Layers

Optionally, the complex may comprise moreover one or more additional layers, conferring on it particular properties linked especially to the conditions of use of the article 1 according to the invention, the environment to which it is exposed, the type of wall 50, the functions that it can advantageously fulfil, etc.

Such additional layers may be situated at any location between the substrate 10 and the free rear face of the article. More precisely, the additional layers may be applied directly onto the substrate 30 10, form part of the layers composing the layer of material to be painted 20 or over the layer of material to be painted.

The article may comprise a plurality of different additional layers spread out over its thickness.

The additional layers may be classified into two major categories: layers applied between the substrate and the layer of material to be painted 20 named surface layers 21, and layers mixed with the layer of material to be painted or applied over said layer 20, named intermediate layers 23.

According to a first embodiment, the additional layer is a surface layer 21 consisting of one or more of the following layers: a layer of varnish, a layer having a decorative appearance, a layer having particular physical and chemical properties.

The surface layer may be a varnish, preferably transparent, applied directly on the moulding substrate 10 before the layer of material to be painted 20. For example, the layer of varnish may be a layer of acryl type, and serve as demoulding layer, especially when the adhesion characteristics of the decorative layer, in other words of the lower layer composing the layer of material to be painted 20, are too high to enable a clean removal of the substrate to be demoulded 10. The varnish may also provide a function of UV barrier, or anti-graffiti functions. Examples of varnish that may be used are: alkyd resins in aqueous phase, polymers in aqueous phase, polyurethane resins in aqueous phase, urethane alkyds in solvent phase, or instead dispersions of acrylic resins in aqueous phase.

Alternatively, the surface layer applied against the layer of material to be painted 20 is a layer 21 adapted to have a particular appearance and/or physical and chemical properties.

Such a layer 21 is intended to be exposed visibly on the wall once the article 1 is applied thereto. It may have a purely decorative role, and/or confer on the complex additional physical-chemical properties.

According to a first aspect, this layer 21 may be composed of flakes, coloured, metallic or nacreous particles, particles having a volume making it possible to confer on the decorative layer a given relief (especially glass microbeads of diameter below 0.5 mm), etc. optionally mixed with a layer of translucent paint or varnish.

According to a second aspect, the surface layer 21 may comprise components having particular physical and chemical properties conferring on the layer 21 a decorative appearance varying as a function of external conditions. It may be for example components that change appearance (colour, gloss, texture, etc.) as a function of the temperature, the light (such as fluorescent, luminescent, retro-reflective particles, etc.), the humidity, the presence of determined chemical or biological elements.

For example, the layer 21 may be water-oil repellent and preserve the layer of material to be painted 20 from aggressions due to the penetration of water and/or greases: an article 1 is then obtained having stain resistant, anti-graffiti properties, etc.

It can also have a hardness above the hardness of the layer of material to be painted 20, and increase the resistance of the complex to impacts and scratching.

According to another embodiment example, the surface layer 21 may be formed of a paint adapted for example in the nautical sector, of the “shark skin” type or, in the aeronautics sector, comprising longitudinal grooves of a characteristic dimension of 25 micrometres.

According to another example, the intermediate layer may receive microgrooves conferring on it optical properties of lens or Fresnel mirror type.

According to a third aspect, the layer 21 may comprise components having determined physical and chemical properties having effects on the environment to which they are exposed (diffusion of biological or chemical substances for example).

Especially, these components may be adapted to react with volatile organic compounds (this is the case for example of zeolites or TiO2 in anatase form which, in the presence of light, has a catalytic effect on the destruction of VOC), may be antifungal agents, or instead antifouling agents adapted to protect the immersed surfaces of ships, etc.

These physical and chemical properties may moreover only be activated after removal of the substrate 10 (by contact with the surrounding environment) or disappearance of a protective layer (not represented) placed at the surface of said layer 21.

According to a second embodiment optionally complementary to the first, an additional layer 23 is an intermediate layer underlying the filler layer, and confers to the complex additional physical and chemical properties compared to known articles. This layer comprises one or more layers having physical and chemical properties, acting as barrier or reinforcement, a conductive layer.

For example, the layer 23 is formed of a heat insulating material, or having specific acoustic properties (absorption, dampening, reflection of sound waves) adapted for example to reduce the ambient noise. Such a material may be especially a polyurethane foam, a porous material of low density, or instead a resin in emulsion comprising a lightening filler and various adjuvants which, while drying, swell and become porous see for example the product SEM-LIGHT distributed by the firm SEMIN).

Alternatively, the intermediate layer 23 is adapted so as to prevent the ionic migration of undesirable substances such as lead or any other toxic element. It may be constituted of a resin which after polymerisation provides sealing, or by a film constituted of a material such as a polyethylene, a polyester, a polypropylene, a polystyrene. This film is treated to have a high surface energy, or is provided with a keying primer so that it adheres to the layers neighbouring it.

According to yet another alternative, the intermediate layer 23 is an armature adapted to reinforce the strength of the complex and render it optionally self-supporting, thereby making it possible to remove the substrate 10 after drying of the layers forming the article 1 in order to facilitate its conditioning and its storage.

Another advantage of this reinforcement layer 23 is to facilitate the use of the article 1 according to the invention in the case of renovations on old and deteriorated substrates, for example friable or likely to crack.

Such a layer 23 may moreover be necessary when the layer 15 of material to be painted 20 is a filler lightly filled with resins, typically less than 15% of resin, and thus includes a high mineral filler content in order to stiffen and even out the thickness of the filler layer 20 that has been applied on the substrate 10, 40.

In the case where the filler 20 is highly filled with resins, in other words where the percentage of resins exceeds this value by 15%, the reinforcement layer 23 is optional and may not be applied on the filler layer 20.

The reinforcement layer 23 comprises for example a glass veil, a glass cloth, glass fibres and/or metallic, mineral or plant fibres, a plastic film, a non-woven or any other component making it possible to stiffen the layer of material to be painted 20 while conserving its adaptability to the wall 50 on which the article 1 is going to be bonded. According to another embodiment, the intermediate layer is a conductive layer 23 (or optionally semi-conducting), and is in contact with the layer of material to be painted 20. It may be held between two electrically insulating layers. The conductive layer may also have patterns and designs making it possible to adjust its electrical parameters and to be connected to electrodes while avoiding any risk.

This conductive layer 23 may thus serve as substrate to calorific components such as electric diodes, heat or light sensors of photovoltaic type, etc., connected by means of cable terminals.

Such an article 1 may then be used in the recovery of energy or, quite the opposite, in the diffusion of energy by lighting or by heating. It may have properties of sound diffusion, electromagnetic diffusion, protection by Faraday cage effect, ferromagnetic properties making it possible to retain a magnetized component.

For example, the conductive layer 23 may be a layer of conducting paint, or comprise conductive components (tin oxides, metallic fibres optionally mixed with glass fibres, a network of resistive wires, a metallic sheet, etc.), a conductive polymer.

It may also be a laminate of fillers having photovoltaic properties, for example two semi-conducting respectively N and P doped layers and placed between two layers intended to collect the electrons emitted by the semi-conducting layers.

A first method will, now be described making it possible to obtain a sheet article 1 for application of decorative layers according to the invention.

In a first step, the surface of the moulding substrate 10 is adjusted so as to confer on it a state of roughness adapted to the desired finish for the decorative layer that will be visible on the wall to be decorated.

This step of adjustment may be implemented on a flat surface or provided with relief patterns of the moulding substrate 10.

In the case of a gloss finish, in other words a finish enabling a reflection similar to a mirror effect to be obtained, the moulding substrate 10 is optionally treated so as to reduce the roughness thereof.

For example, for a substrate 10 of PET sheet type, the surface condition of the substrate already being sufficiently smooth in itself, no adjustment is necessary.

In the case of a satin or matt finish, the surface condition is adjusted by mechanical or chemical abrasion according to known abrasion techniques, for example by sandblasting or acid etching. The greater the abrasion carried out, the more the finish of the decorative layer obtained will be matt. This adjustment may also be carried out by application on the substrate of a layer containing a filler of controlled fineness, for example silica having a grain size of the order of 100μ.

In the case for example of abrasion by sandblasting, the nature of the sand used (rolled or ground), the pressure applied and the treatment time make it possible to adjust the degree of roughness, and thus the finish of the decorative layer. For example, it is possible to use sand based on corundum or glass beads.

For example, a sanding carried out on a polyethylene terephthalate using a corundum F220 powder projected at a pressure of 4 bars gives a roughness of 1.43 μm and a gloss of 6.1 measured with a Konica Minolta spectrophotocolorimeter, model CM-600d.

This adjustment of the surface of the substrate makes it possible according to another application to obtain a micro-texturing of the surface, so as to achieve a moulding of a great finesse of the visible layer.

To do this, the moulding substrate 10 may be machined, or moulded, or thermoformed beforehand to give to it an exterior surface of the article 25 having the desired properties:

For an application intended for ships, a filler is created similar to shark skin, the asperities of which create micro-perturbations which facilitate hydrodynamic flow.

For an aeronautical application, grooves of longitudinal of triangular section or “riblets”, of a dimension characteristic of 25 microns are created to reduce the vapour trail.

The micro-texturing can also create particular optical properties on the final external surface of the article 1. For example, the moulding on the surface of the moulding substrate 10 of a Fresnel lens makes it possible to obtain, at the end of the method, when the layers are transparent, an article having the property of a Fresnel optical lens.

In another embodiment, if a surface layer 21 is a metallised surface, a Fresnel mirror is obtained.

Furthermore, according to the type of moulding substrate 10 used, the method includes moreover a step during which the surface of the substrate 10 on which will be applied the first layer of the complex (in other words a surface layer 21 or the filler layer 20) is treated so as to adjust its surface energy, and thus its degree of adherence.

For example, in the case of a siliconised paper, the wettability of the substrate 10 is very low for a material to be painted of the glycerophthalic paint type, thereby creating surface irregularities, even the appearance of bubbles during drying. It may thus prove to be necessary to treat the surface so as to increase is surface energy, for example by ionisation, corona treatment or plasma torch.

In a second step, optional, a surface layer 21 is applied according to conventional techniques as a function of the type of layer on the moulding substrate 10 (especially by spraying, squeegee, with a roller, etc.).

For example, in the case of a layer of varnish, the layer is applied according to conventional material application methods, for example by heliography, screen printing, flexography, by spraying, if appropriate in combination with a squeegee or any other spread coating means.

It will be noted here that according to the application, the type of substrate and the type of varnish, the quantity applied may vary widely. The same variety of thicknesses will here be found as traditional techniques of applying materials to be painted such as varnishes and paints. The layer of varnish is then dried, preferably before the implementation of the following step.

In a particular embodiment, the surface layer 21 is composed of a first varnish of anti-graffiti type. This type of varnish has the characteristic, after curing, of not enabling the bonding of an additional layer. Before curing, a second layer of varnish is then applied, for example of acrylic type. The article 10 constituted of two layers of varnish can be printed the wrong way round. After application, it will be definitively protected by the layer of anti-graffiti varnish.

In the case of a purely decorative intermediate layer 21, for example a layer of coloured particles, said particles are simply distributed in a random manner, or according to a predefined decorative scheme, on the surface of the substrate 10, and are immersed in a binder which may be a varnish or a material to be painted.

In a third step, the filler layer 20 is spread in one or more layers on the moulding substrate 10, or, if appropriate, on the surface layer 21 previously applied, according to conventional techniques adapted to the type of material (more or less thick paste) spread out.

The free surface through which the solvents and water evaporate is thus the surface which is intended to be applied against the wall 50, unlike traditional methods in which it is the visible surface of the filler layer 20 that dries first. Yet, during drying, this evaporation creates irregularities in the free surface evaporation, which makes in general an additional finishing step necessary (typically, a varnish sanding followed by a re-application of filler on the surface) if a smooth high quality finish is desired.

Thus, by leaving to dry the layer on the substrate to be demoulded 10, the surface of the article that will be visible when this will be applied on the wall is that which is in contact with the moulding substrate 10, and not the free surface through which the solvents escape. It is thus possible to control the appearance of the visible surface, without an additional finishing step.

Advantageously, in the case where the layer 21 comprises two layers of material to be painted, two layers may be applied having different colours and thicknesses, so as to improve the rendering of the external layer that will be visible when the article 1 will applied on the wall 50. Indeed, monolayer (or multilayer and monocolour) articles are not suitable for all lighting, and are substantially less aesthetic than multilayer and multi-colour paints.

For example, the application of an undercoat of red paint under a layer of blue paint makes it possible to obtain in the end a brighter blue.

Each layer composing the layer of material to be painted is dried as work proceeds, for example in a dryer or in a high frequency micro-wave oven.

The filler layer 20 is for its part dried preferably in one go at the end of its application on the substrate 10.

According to a modality of the method, during production, the layer constituting the back of the article, which may be either the filler layer 20 itself, or an intermediate layer 23, may be textured, for example by application of a roller having reliefs and carrying out an embossing of the surface. This operation lightens the article while conserving its mechanical properties and its surface appearance, and facilitate moreover its application on a roughly prepared wall.

When the article 1 includes an intermediate layer 23, this may be produced at any moment during the production method.

In the case of an intermediate layer having an effect of mechanical reinforcement and barrier in the form of a film, said film is treated to facilitate bonding on the filler layer, and its free face constitutes the back of the article.

Alternatively, the conductive layer 23 is in the form of fibres, for example mineral, plant and/or metallic fibres. The fibres are then mixed with the filler then applied on the filler layer 20.

In the case of a conductive layer 23, this is formed over the layer of material to be painted 20, or within the layer of material to be painted 20 (between two layers of paint for example). The conductive layer 23 is then directly applied against the filler layer 20 before drying it, in order to improve their adhesion. Optionally, the conductive layer 23 is then covered with a new filler layer (not represented) in order to ensure its adherence and its solidarity with the filler 20.

This conductive layer may be applied either as powder, either in the form of a perforated conductive sheet or finally in the form of network or fabric of conductive or resistive wires, in the form of a conductive polymer.

This sheet article 1 may be left as is or undergo optional ulterior operations.

When, after production, the film formed is self-supporting, it is possible to remove the moulding substrate 10.

This enables for example the printing of the external layer of the article that was in contact with the substrate 10.

This also enables the recovery of the moulding substrate 10 and its optional replacement by a siliconised paper, a biodegradable substrate or any other peelable substrate. The manufacturer can thus allow himself to use a moulding substrate 10 of better quality in so far as it may be reused. Furthermore, the optional biodegradability of the peelable substrate 30 makes it possible, in addition to respecting the environment, to guarantee that the client will not try to reuse the substrate in order to reproduce himself the sheet article 1 according to the invention.

Alternatively, the moulding substrate may also be treated to increase the porosity thereof, by mechanical or chemical action. This operation has the advantage of facilitating the drying of the article once in place on the wall.

After the different steps of application and drying, the sheet article 1 may be cut according to needs and conditioned in the form of panels or rolls.

The steps of application of the sheet article 1 on a substrate to be treated will now be described, with reference to FIG. 2. The example will be taken of a sheet article 1 provided with the moulding substrate 10, a surface layer 21, a filler layer 20 and a conductive layer 23.

It will be noted that the application can be carried out on extremely varied substrates (walls, joinery, furniture, etc.), made of also varied materials, having flat or curved faces (but preferably regular surfaces) and which can have surface defects according to the following process:
application of an adhesive in the form of paste on the back of the article 1 and/or on the wall to be decorated;
application of the article 1 against the wall to be decorated 50 and pressing down from top to bottom and from the centre towards the edges;
drying the article in place while maintaining it. The drying may last from 12 to 48 hours according to the type of adhesive used, and the nature of the substrate.

A wall 50 is then obtained comprising successively an adhesive layer 40, a conductive layer 23, a filler layer 20 and optionally one or more surface layers 21, the assembly being able to undergo or not an additional finishing step (especially application of paint).

As mentioned above, the visible surface of the article 1 corresponds to the surface that was in contact with the moulding substrate 10, and thus has a high quality appearance which does not need to be retreated.

For example, if the moulding substrate 10 of the article 1 that is applied on the wall 50 is a smooth PET substrate, the visible surface of the article 1 is also flat and smooth, giving a gloss finish.

If on the other hand the substrate 10 has been treated by mechanical or chemical abrasion, the visible surface of the article 1 will also be smooth but with a satin or matt appearance.

In all cases, no finishing step is necessary in order to obtain a high quality surface, which reduces both the difficulty of the application of the material to be painted and the necessary labour, while providing an easily reproducible quality result.

Alternatively, this method may be applied to articles for which the moulding substrate 10 has been removed after drying of the filler layer 20 during the production method.

According to an embodiment, the layer of adhesive material 40 applied on the wall 50 is a filler layer, preferably of the same type as the filler used for the article 1. Indeed, such a filler makes it possible to maintain the article in position when it dries, and has the advantage of preparing the wall 50 while filling surface irregularities such as fissures, holes, etc. It makes it possible moreover to flatten or at least partially flatten the wall 50 or quite the opposite to confer on it a curved shape, according to the desired effect.

Advantageously, the adhesive layer 40 is applied in a uniform manner and is roughly smoothed.

According to another embodiment, the adhesive layer 40 is a traditional adhesive.

The free face opposite to the moulding substrate 10, here the face comprising the conductive layer 23, is then applied against the adhesive layer 40, then the moulding substrate 10 is removed. The assembly is then left to dry.

If the article 1 is conditioned in the form of roll, it may prove to be necessary to maintain the article 1 applied against the wall 50 by exerting a pressure on the surface of the moulding substrate 10 until the adhesion force between the wall 50 and the adhesive layer 40 is sufficient to maintain it in position. Indeed, according to the layers composing the article 1, it may have a shape memory which risks folding it back on itself and disbanding it from the wall 50.

Furthermore, it is no longer useful to prepare the wall 50 beforehand in order to obtain a surface that is perfectly smooth, flat and devoid of irregularities 10 before applying the article 1, unlike conventional methods, since it suffices to apply the article directly on an adhesive layer 40 such as a roughly smoothed filler layer, so as to plug the largest fissures present on the wall 50.

According to another advantageous aspect, given that the article 1 is manufactured industrially, it is possible to recover a large part of any volatile organic compounds before it is commercialised and to destroy them, for example by incineration, thereby avoiding them dispersing in nature at the time of the application of the filler on the wall.

According to the surface area of the wall to be decorated 50 and the dimensions of the sheet article 1, a single article 1 according to the invention may prove to be insufficient to cover the totality of the surface of the wall. It then suffices to position the articles edge to edge, leaving a minimum space between them. The resulting joint is not very visible. It may moreover be masked by the localised application of a material to be painted of colour similar to that of the article, covered by a tape of moulding substrate.

Finally, a defect during application or on the worksite may be masked by a particular repair method: in this method, on the part to be repaired is spread a filler of composition similar to that of the article, having the minimum drying shrinkage, and this still fresh filler is covered by a moulding substrate component, taking care not to trap air bubbles. Advantageously, when the sheet article has a decorative surface layer 21, the moulding substrate used for the repair comprises moreover this same decorative layer already applied, in a separable manner.

The moulding substrate being very light, capillarity forces are sufficient to maintain it in place.

After a drying time, this substrate is removed.

Obviously, the present invention is in no way limited to the embodiments described above and represented in the drawings, but those skilled in the art will know how to make numerous alternatives and modifications.

1. Article for sheet filler (1) intended to be applied on a wall (50), characterised in that it comprises:
a moulding substrate; and
a filler layer, disposed on a first face of the moulding substrate.

2. Article according to claim 1, comprising an additional layer disposed between the filler layer and the first face of the moulding substrate, so as to form a surface layer after application of the article on the wall.

3. Article according to claim 2, in which the additional layer is a decorative layer.

4. Article according to claim 3, in which the decorative layer comprises one at least of the components of the following group: a paint, a varnish, coloured, metallic, nacreous particles, microbeads, fluorescent particles, luminescent particles, retro-reflective particles, held or not in a binder.

5. Article according to claim 2, in which the surface layer is formed of a material able to react with the environment to which it is exposed.

6. Article according to claim 5, in which the surface layer is made of a material selected from: a microtextured paint, a water-oil repellent medium, zeolites, antifungal agents, anti-fouling agents, biocides, decontaminating agents.

7. Article according to claim 5, in which the surface layer has physical and chemical properties activatable with air, water or light.

8. Article according to one of claims 5 to 7, in which the surface layer is protected by a temporary protective layer.

9. Article according to one of claims 2 to 8, comprising an additional layer on the side of the filler layer opposite to the moulding substrate, so as to constitute an intermediate layer after application of the article on the wall.

10. Article according to claim 9, in which the intermediate layer is selected from: a mechanical reinforcement layer, a barrier forming layer, an electrically conductive layer, a layer having ferromagnetic properties.

11. Article according to claim 10, in which the mechanical reinforcement layer is made of an anti-fissuring material.

12. Article according to claim 10, in which the barrier forming layer forms a heat and/or acoustic barrier and is formed with an insulating material and/or a porous material.

13. Article according to claim 10, in which the barrier forming layer is a continuous layer forming a barrier to the migration of atomic, molecular or ionic species.

14. Article according to claim 10, in which the conductive layer is made in a form selected from: a conductive sheet, a network of resistive wires, a conductive polymer, conductive particles dispersed in a binder.

15. Article according to claim 14, further comprising two electrically insulating layers situated on either side of the conductive layer.

16. Article according to one of claims 14 and 15, in which the conductive layer includes fittings for its electrical connection with the exterior.

17. Article according to claim 16, which further comprises thin sensor means connected to said fittings.

18. Article according to claim 10, in which the intermediate layer is a layer having ferromagnetic properties formed of ferromagnetic particles contained in a binder.

19. Article according to one of claims 1 to 18, in which the filler layer comprises at least two thicknesses of different materials, at least one of which is a filler.

20. Article according to claim 19, in which the filler layer comprises a thickness of filler of a first colour and a thickness of paint of a second colour different to the first.

21. Article according to one of claims 1 to 20, characterised in that the filler comprises a filler in the form of resin of a flexibility and a thickness enabling the article to be formed in a roll.

22. Article according to one of claims 1 to 21, in which the filler contains reinforcement fibres.

23. Article according to one of claims 1 to 22, in which the filler layer includes an embossing on its face opposite to the moulding substrate.

24. Article according to one of claims 1 to 23, in which the moulding substrate or at least one surface part thereof is selected from the group comprising:
polyethylene terephthalate, polyethylenes with additives, siliconised papers, papers coated with a mould release agent, woven and non-woven fibres covered with a film forming agent with low surface energy, silicones, Teflon®.

25. Article according to one of claims 1 to 24, in which the first face of the moulding substrate has a controlled surface condition and surface energy.

26. Article according to claim 25, in which the first face of the moulding substrate has patterns in hollows and/or in relief.

27. Article according to one of claims 1 to 26, conditioned in plate form.

28. Article according to one of claims 1 to 26, conditioned in roll form.

29. Article according to one of claims 1 to 28, in which the moulding substrate has a thickness comprised between around 5 μm and 100 μm, and more specifically between around 20 and 50 μm.

30. Article according to one of claims 1 to 29, in which the filler layer has a thickness comprised between around 0.5 mm and 5 mm.

31. Method for producing an article for dry filler application on a wall, characterised in that it comprises the steps consisting in:
(i) feeding a machine with a moulding substrate;
(ii) applying on one of the faces of the moulding substrate a filler layer; and
(iii) drying the filler layer.

32. Method according to claim 31, which comprises a step of application of an additional layer on the moulding substrate prior to the application of the filler, to form an article with a surface layer according to one of claims 2 to 8.

33. Method according to claim 32, which comprises a step of application of another additional layer on the surface layer, to form an article according to one of claims 9 to 18.

34. Method according to one of claims 32 and 33, in which the step of application of the additional layer comprises the application of a powder and a treatment of the powder.

35. Method according to claim 33, which comprises the application of an additional conductive layer on a first filler layer, and the application of a second filler layer on the conductive layer.

36. Method according to one of claims 31 to 35, further comprising the application of a surface treatment on the face of the article opposite to the moulding substrate so as to favour its bonding.

37. Method according to one of claims 31 to 36, which among others comprises the subsequent steps consisting in:
separating the moulding substrate from the article; and
printing the surface of the article that was in contact with the moulding substrate in a printing machine.

38. Method according to one of claims 31 to 37, which comprises among others the subsequent steps consisting in:
separating the moulding substrate from the article; and
applying a peelable substrate in place of the moulding substrate.

39. Method for producing a moulding substrate for an article according to one of claims 1 to 30, characterised in that it comprises the following steps:
(i) defining a first material for one face of the moulding substrate;
(ii) as a function of a relief effect sought after for the article and the nature of a second material to apply firstly on the first material, defining a target surface condition and surface energy for said face of the moulding substrate, on which the article is intended to be formed, so as in particular to obtain a wettability by said material and a demouldable character of the article after drying; and
(iii) treating a face of a sheet having said first material on said face to obtain the target surface condition and surface energy, to obtain thereby the moulding substrate.

40. Method according to claim 39, in which the moulding substrate or at least one surface part thereof is selected from the group comprising: polyethylene terephthalate, polyethylenes with additives, siliconised papers, papers coated with a demoulding agent, woven and non-woven fibres covered with a film forming agent with low surface energy, silicones, Teflon®.

41. Method according to claim 40, in which the thickness of the sheet is comprised between around 5 μm and 100 μm, and more specifically between around 20 and 50 μm.

42. Method according to claim 40 or 41, in which, to obtain the target surface condition, the step (iii) is implemented by abrasion.

43. Method according to claim 42, in which the abrasion is a mechanical abrasion by sandblasting.

44. Method according to claim 42, in which the abrasion combines a chemical attack and the application of a particulate material.

45. Method according to claim 40 or 41, in which, to obtain the target surface condition, the step (iii) is implemented by formation of hollows and/or reliefs with a technique selected from hot moulding and etching.

46. Method according to claim 45, in which the hollows and/or reliefs have a mean geometric period comprised between around 20 and 500 μm.

47. Method according to one of claims 42 to 46, in which, to obtain the target surface energy, the step (iii) comprises a treatment selected from: a corona treatment and exposure to a plasma gun.

48. Method according to one of claims 42 to 46, in which, to obtain the target surface energy, the step (iii) comprises the application of a surface energy modifying product.

49. Method according to claim 48, in which the product is a latex, so as to increase the surface energy.

50. Method according to claim 48, in which the product is a substance with low intrinsic surface energy, so as to lower the surface energy.

51. Method of applying an article according to one of claims 1 to 30 on a wall, comprising the steps consisting in:
(i) applying an adhesive on the wall and/or on the free face of the article opposite to the moulding substrate;
(ii) applying said free face against the wall;
(iii) removing the moulding substrate.

52. Method of applying an article obtained by the method according to claim 38 on a wall, comprising the steps consisting in:
(i) applying an adhesive on the wall and/or on the free face of the article opposite to the peelable substrate;
(ii) applying said free face against the wall;
(iii) removing the peelable substrate.

53. Method according to claim 51 or 52, in which the adhesive is a filler in paste form.

54. Method according to claim 51 or 52, for the application of an article according to claim 8, which further comprises a step of removal of the temporary protective layer.

55. Method of finishing or repairing a wall coated with an article by the method according to one of claims 51 to 54, characterised in that it comprises the following steps:
application of a filler in paste form similar to that used to form the filler layer of the article on a zone to be finished or to be repaired;
before drying of the filler, application of a moulding substrate similar to that used to form the article against the filler in said zone; and
after a period of drying, removal of the moulding substrate.
removal of the temporary protective layer.

56. Method of finishing or repairing a wall coated with an article by the method according to one of claims 51 to 54, the article comprising a surface layer, characterised in that it comprises the following steps:
application of a filler in paste form similar to that used to form the filler layer of the article on a zone to be finished or to be repaired;
before drying of the filler, application of a moulding substrate similar to that used to form the article against the filler in said zone, said moulding substrate bearing a layer similar to said surface layer; and
after a period of drying, removing the moulding substrate while leaving in place said layer initially borne by the moulding substrate.
